(19) United States
(12) Patent Application Publication
(10) Pub. No.: US 2006/0043172 A1
(43) Pub. Date: Mar. 2, 2006

(54) Apparatus for showing disposable amount of electronic ticket card on portable electronic device and wirelessly adding value to the electronic ticket card by means of the portable electronic device and method therefor

(75) Inventors: David Ho, Taipei (TW); Hai-Feng Tang, Shanghai City (CN); Chih-Chung Hung, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/178,437

(22) Filed: Jul. 12, 2005

(30) Foreign Application Priority Data
Sep. 2, 2004 (TW) 093126518

(51) Int. Cl. G06K 5/00

(52) U.S. Cl. 235/380

(57) ABSTRACT

The present invention relates to an apparatus for showing disposable amount of an electronic ticket card on a portable electronic device and wirelessly adding value to the electronic ticket card by means of the portable electronic device and a method therefore, wherein the electronic ticket card includes a non-contact value-adding memory chip, a sensor coil, a processor having a serial communication module and an auxiliary circuit, fare per transaction is adapted to be wirelessly deducted from an amount stored in the non-contact value-adding memory chip by the sensor coil, and the serial communication module is adapted to cooperate with the auxiliary circuit to enable the electronic ticket card to communicate with the portable electronic device through serial communication.

### FIELD OF THE INVENTION

The present invention relates to portable electronic device (e.g., cellular phone or PDA (personal digital assistant)) applications, more particularly to an apparatus for showing disposable amount of an electronic ticket card on a portable electronic device and wirelessly adding value to the electronic ticket card by means of the portable electronic device and method therefore, so as to combine advantageous features such as popularity of a portable electronic device and convenience of an electronic ticket card together as one, bring users great convenience in their daily life and effectively increase the selling point of the portable electronic device.

### BACKGROUND OF THE INVENTION

Tickets of boarding a subway or bus are diversified as technology advances. For example, many subway systems in big cities throughout the world offer a plastic card. The plastic card is indeed an electronic ticket card as viewed in many aspects. A passenger is allowed to add value to an electronic ticket card once disposable amount thereof is not sufficient from the point of view of the passenger. Such electronic ticket card is also called traffic card, smart card or EasyCard (e.g., one used in Taipei). The electronic ticket card has the same size as a credit card or bank card widely used throughout the world. Differences therebetween are that a non-contact value-adding memory chip and a sensor coil are built in the electronic ticket card for storing large amount of data (e.g., consumer spending modes or the like). In use, a passenger may place the electronic ticket card proximate a sensor zone of a card reader and hold the electronic ticket card to scan it. The non-contact value-adding memory chip and the sensor coil of the electronic ticket card are thus enabled in which a certain amount is wirelessly deducted from disposable amount of the electronic ticket card by the non-contact value-adding memory chip. Such transaction is fast and easy.

Identifying time of the electronic ticket card is very short. Typically, identifying time of the electronic ticket card is about 0.4 second which is much faster than the time (e.g., 4 to 5 seconds) of reading data by a card reader. Also, wear of the electronic ticket card is much less due to no contact with card reader. An electronic ticket card is valid for a number of years and a passenger is thus free of being bothered by preparing change and buying tickets frequently as long as it is valid. Moreover, a passenger is allowed to add value to an electronic ticket card once disposable amount thereof is not sufficient. As such, electronic ticket cards are widely employed in many subway systems.

However, an electronic ticket card is susceptible to being lost due to small size. Also, disposable amount thereof cannot be known by simply viewing. Instead, a passenger has to place an electronic ticket card on sensor zone of an enquiry machine in order to know remaining credit of the electronic ticket card. However, enquiry machines are located in only selected places (e.g., subway stations). Further, for adding value a passenger has to go to a specific place with the installation of a value-adding machine (e.g., subway station, convenient store, or the like). This is really not convenient as viewed by passengers.

A wide variety of portable electronic devices (e.g., cellular phones, PDAs (personal digital assistants), etc.) are commercially available in an even faster pace in recent years as communication and network technologies advance. Moreover, such portable electronic devices are widely used by more and more people due to its advantages such as compact, multifunctional, and inexpensive. Nowadays, they are the most popular communication tools among people. In another aspect, more and more companies spend a lot of money on the development of portable electronic device with advanced features due to its popularity in recent years. As a result, quality, user friendliness, and functions thereof are greatly improved. For manufacturers, it is important to know that distinguished features of a portable electronic device are the key to success in this competitive market.

Hence, a need has arisen for an apparatus mounted in an electronic ticket card and cooperated therewith such that a user may operate a portable electronic device to read disposable amount of the electronic ticket card and show the same on the portable electronic device. The user may also operate the portable electronic device to and add value to the electronic ticket card when a disposable amount thereof is not sufficient. That is, the functions of a portable electronic device, disposable amount check and showing of the electronic ticket card, and value adding to the electronic ticket card are combined. It is believed that convenience arisen by both a portable electronic device and an electronic ticket card can be enjoyed by a person who owns them.

### SUMMARY OF THE INVENTION

After considerable research and experimentation, an apparatus for showing disposable amount of an electronic ticket card on a portable electronic device and wirelessly adding value to the electronic ticket card by means of the portable electronic device and method therefor according to the present invention have been devised so as to overcome the above drawbacks (e.g., impossible of knowing disposable amount of an electronic ticket card by viewing it, and for adding value to the electronic ticket card a passenger having to go to a specific place with the installation of a value-adding machine) of the prior art despite of superiority, progressiveness, and convenience of electronic ticket card. By utilizing the apparatus and the method, advantageous features such as popularity of the portable electronic device are incorporated into the electronic ticket card (i.e., combined as one) so as to bring great convenience to users.

It is an object of the present invention to in an electronic ticket card including a non-contact value-adding memory chip, a sensor coil, a processor having a serial communication module, and an auxiliary circuit wherein fare per transaction is adapted to be wirelessly deducted from an amount stored in the non-contact value-adding memory chip by the sensor coil, and the serial communication module is adapted to cooperate with the auxiliary circuit to enable the electronic ticket card to communicate with a portable electronic device (e.g., cellular phone or PDA) through serial communication, provide a method comprising operating the portable electronic device to read an amount from the non-contact value-adding memory chip or write an amount thereinto through serial communication; showing the read or written amount on a display of the portable electronic device for viewing; and enabling a user to know a disposable amount of the electronic ticket card immediately and wirelessly adding value thereto in time when the disposable amount is not sufficient. By utilizing the method, the prior drawbacks such as impossible of knowing disposable amount of an electronic ticket card by viewing it, and for adding value to the electronic ticket card a passenger having to go to a specific place with the installation of a value-adding machine, and inconvenience brought to users are overcome.

It is another object of the present invention to, by utilizing the apparatus and the method of the present invention combine advantageous features such as popularity of a portable electronic device and advantageous features such as convenience of an electronic ticket card as one. This is a contrast to existing portable electronic device or electronic ticket card having a single function only. Moreover, the invention is cost effective and is easy to embody. Thus, great convenience can be brought to users in their daily life. Hence, the invention is an ergonomic design.

The above and other objects, features and advantages of the present invention will become apparent from the following detailed description taken with the accompanying drawings.

### BRIEF DESCRIPTION OF THE DRAWINGS

FIG. 1 is a schematic block diagram of an electronic ticket card adapted to cooperate with a portable electronic device for showing disposable amount thereof on the portable electronic device and wirelessly adding value to the electronic ticket card by means of the portable electronic device according to the invention;

FIG. 2 is a flow chart illustrating a process of wirelessly adding value to the electronic ticket card by means of the portable electronic device according to the invention;

FIG. 3 is a flow chart illustrating a process of showing disposable amount of the electronic ticket card on the portable electronic device according to the invention; and

FIG. 4 is a plan view of the electronic ticket card to be mounted on the portable electronic device for schematically depicting how to show disposable amount of the electronic ticket card on the portable electronic device and wirelessly adding value to the electronic ticket card by means of the portable electronic device according to the invention.

### DETAILED DESCRIPTION OF THE PREFERRED EMBODIMENTS

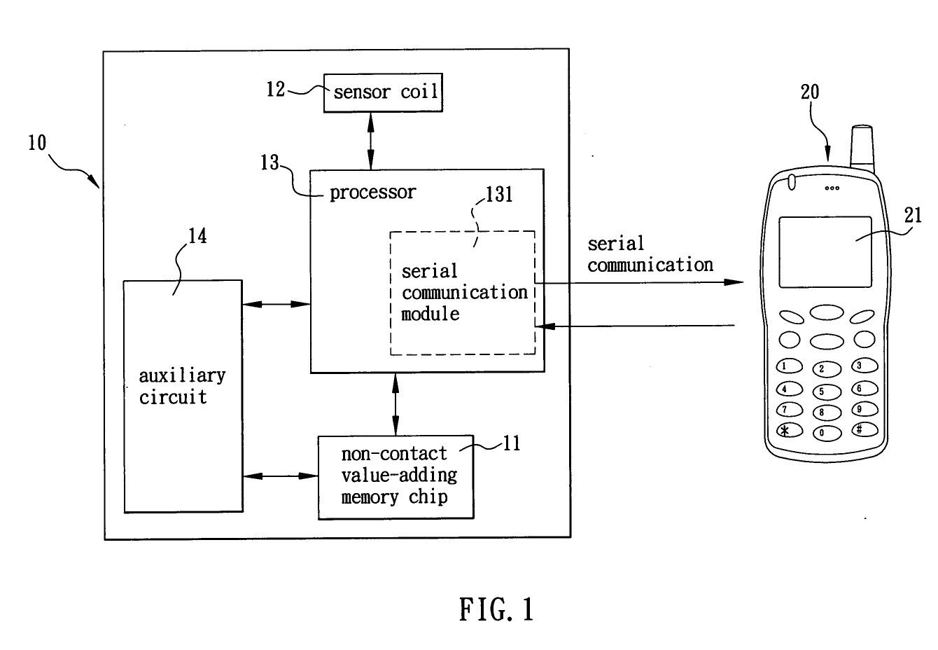

The invention is directed to apparatus for showing disposable amount of an electronic ticket card on a portable electronic device and wirelessly adding value to the electronic ticket card by means of the portable electronic device and method therefor. Referring to FIG. 1, for carrying out the method in an electronic ticket card 10 there are provided a non-contact value-adding memory chip 11 and a sensor coil 12. In operation, fare per transaction can be wirelessly deducted from amount stored in the non-contact value-adding memory chip 11 of the electronic ticket card 10 by the sensor coil 12. Further, a processor 13 and an auxiliary circuit 14 are provided in the electronic ticket card 10. The processor 13 comprises a serial communication module 131. The provision of the serial communication module 131 and the auxiliary circuit 14 enables the electronic ticket card 10 to communicate with a portable electronic device (e.g., cellular phone or PDA) 20 through serial communication. Also, the portable electronic device 20 is adapted to read amount from the non-contact value-adding memory chip 11 or write amount into the non-contact value-adding memory chip 11 through serial communication. The read or written amount is then shown on a display 21 of the portable electronic device 20 for user viewing. The user thus knows disposable amount of the electronic ticket card 10 immediately and is able to add value thereto in due time when the disposable amount is not sufficient. This feature can bring great convenience to users.

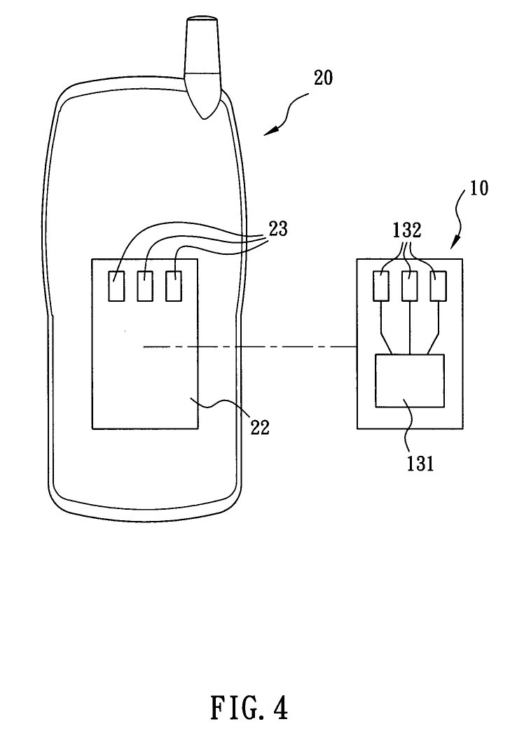

It is known that a conventional electronic ticket card can only be read by a card reader (not shown). That is, data is read from the non-contact value-adding memory chip of the conventional electronic ticket card. To the contrary, referring to FIG. 4, hardware of the invention is configured to provide a space 22 on one surface of the portable electronic device 20 (e.g., the back of the portable electronic device 20). A plurality of first contacts 23 are formed in the space 22 and are electrically connected to a processor (not shown). Further, a plurality of second contacts 123 are formed in the electronic ticket card 10 and are electrically connected to the serial communication module 131. In a case of the electronic ticket card 10 inserted in the space 22, the contacts 23 and 132 are connected together. A user is thus able to operate the portable electronic device 20 to read amount from the non-contact value-adding memory chip 11 of the electronic ticket card 10 or write amount thereinto through serial communication. The user thus knows disposable amount of the electronic ticket card 10 immediately and is able to add value thereto in due time when the disposable amount is not sufficient.

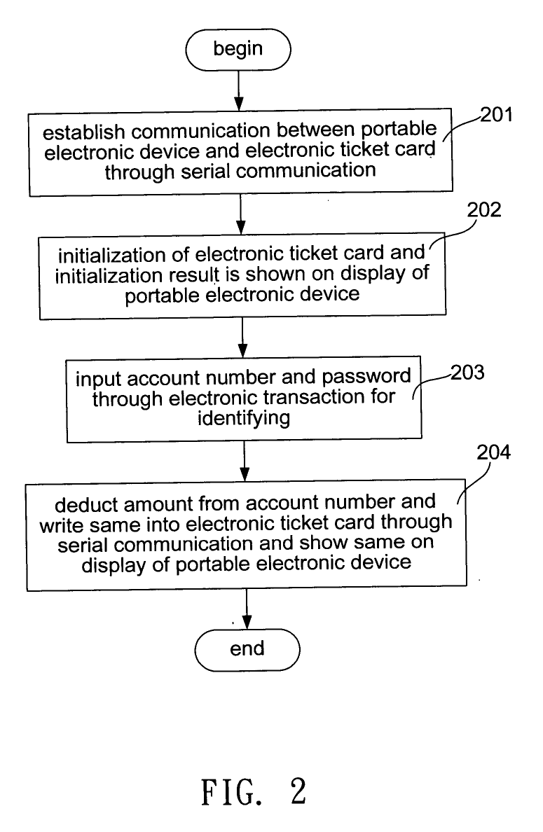

Referring to FIG. 2, this flow chart illustrates a process of wirelessly adding value to the electronic ticket card 10 by means of the portable electronic device 20 after establishing a communication therebetween according to the invention.

Step 201, a user operates the portable electronic device 20 to establish a communication with the processor 13 of the electronic ticket card 10 through serial communication.

Step 202, the user operates the portable electronic device 20 to initialize the electronic ticket card 10 and result of the initialization is shown on the display 21 of the portable electronic device 20.

Step 203, for identifying purpose an electronic account number of the user and a password of the electronic account number are obtained from a provider of the electronic ticket card 10 through an electronic transaction. This step aims at controlling an authorized use of the electronic ticket card 10. Note that the control format complies with ISO 14443 standard about electronic ticket card and it is not the subject sought to be protected by the invention. Accordingly, further description is omitted for purpose of brevity.

Step 204, the user operates the portable electronic device 20 to deduct a certain amount from a bank account number and write same into the non-contact value-adding memory chip 11 of the electronic ticket card 10 through serial communication. Also, the amount is shown on the display 21 of the portable electronic device 20. The process of wirelessly adding value to the electronic ticket card 10 by means of the portable electronic device 20 ends.

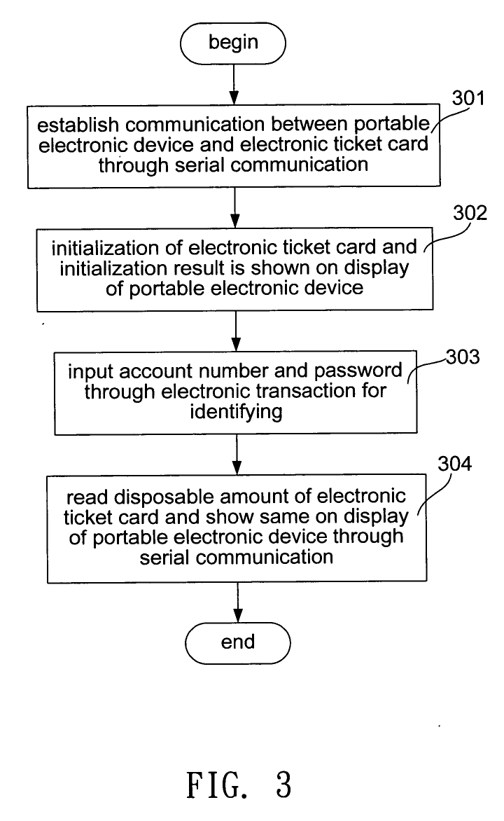

Referring to FIG. 3, this flow chart illustrates a process of showing disposable amount of the electronic ticket card 10 on the portable electronic device 20 after establishing a communication therebetween according to the invention.

Step 301, a user operates the portable electronic device 20 to establish a communication with the processor 13 of the electronic ticket card 10 through serial communication.

Step 302, the user operates the portable electronic device 20 to initialize the electronic ticket card 10 and result of the initialization is shown on the display 21 of the portable electronic device 20.

Step 303, for identifying purpose an electronic account number of the user and a password of the electronic account number are obtained from a provider of the electronic ticket card 10 through an electronic transaction. This step aims at controlling an authorized use of the electronic ticket card 10. Note that the control format complies with ISO 14443 standard about electronic ticket card and it is not the subject sought to be protected by the invention. Accordingly, further description is omitted for purpose of brevity.

Step 304, the user operates the portable electronic device 20 to read a disposable amount from the non-contact value-adding memory chip 11 of the electronic ticket card 10 and the disposable amount is shown on the display 21 of the portable electronic device 20 through serial communication. The process of showing disposable amount of the electronic ticket card 10 on the portable electronic device 20 ends.

It is clear from above that by utilizing the apparatus and the method of the invention the portable electronic device 20 is adapted to read amount from the non-contact value-adding memory chip 11 of the electronic ticket card 10 or write amount into same through serial communication. The read or written amount is then shown on a display 21 of the portable electronic device 20 for user viewing. The user thus knows disposable amount of the electronic ticket card 10 immediately and is able to add value thereto in due time when the disposable amount is not sufficient. The invention can substantially eliminate the above drawbacks of the prior art. Moreover, by utilizing the apparatus and the method of the invention advantageous features (e.g., popularity) of the portable electronic device 20 and advantageous features (e.g., convenience) of the electronic ticket card 10 can be combined as one. This is a contrast to existing portable electronic device or electronic ticket card having a single function only. Moreover, the invention is cost effective and is easy to embody. Thus, great convenience can be brought to users in their daily life. Hence, the invention is an ergonomic design.

While the invention herein disclosed has been described by means of specific embodiments, numerous modifications and variations could be made thereto by those skilled in the art without departing from the scope and spirit of the invention set forth in the claims.

What is claimed is:

1. A method for showing a disposable amount of an electronic ticket card on a portable electronic device and wirelessly adding value to the electronic ticket card by means of the portable electronic device, wherein the electronic ticket card includes a non-contact value-adding memory chip, a sensor coil, a processor having a serial communication module, and an auxiliary circuit, fare per transaction is adapted to be wirelessly deducted from an amount stored in the non-contact value-adding memory chip by the sensor coil, and the serial communication module is adapted to cooperate with the auxiliary circuit to enable the electronic ticket card to communicate with the portable electronic device through serial communication, said method comprising the steps of:
reading or writing an amount from the non-contact value-adding memory chip through serial communication by the portable electronic device;
showing the read or written amount on a display of the portable electronic device for viewing.

2. The method of claim 1, wherein in response to establishing a communication between the electronic ticket card and the portable electronic device for wirelessly adding value to the electronic ticket card by means of the portable electronic device, the method further comprises the steps of:
establishing a communication with the processor of the electronic ticket card through serial communication by the portable electronic device;
initializing the electronic ticket card and showing a result of the initialization on the display of the portable electronic device;
identifying and controlling an authorized use of the electronic ticket card by means of an electronic account number and a password provided from a provider of the electronic ticket card and before an electronic transacting.
deducting an amount from the electronic account number and writing same into the non-contact value-adding memory chip of the electronic ticket card through serial communication by the portable electronic device
showing the amount on the display of the portable electronic device through serial communication;
ending the method of wirelessly adding value to the electronic ticket card by means of the portable electronic device.

3. The method of claim 1, wherein in response to establishing a communication between the electronic ticket card and the portable electronic device for showing a disposable amount of the electronic ticket card on the portable electronic device, the method further comprises the steps of:
establishing a communication with the processor of the electronic ticket card through serial communication by the portable electronic device;
initializing the electronic ticket card and showing a result of the initialization on the display of the portable electronic device;
identifying and controlling an authorized use of the electronic ticket card by means of an electronic account number and a password provided from a provider of the electronic ticket card and before an electronic transacting,
reading a disposable amount from the non-contact value-adding memory chip of the electronic ticket card through serial communication by the portable electronic device;
showing the amount on the display of the portable electronic device through serial communication;
ending the method of showing the disposable amount of the electronic ticket card on the portable electronic device.

4. An apparatus for showing a disposable amount of an electronic ticket card on a portable electronic device and wirelessly adding value to the electronic ticket card by means of the portable electronic device, comprising:
a portable electronic device comprising a space on a surface, a processor, and a plurality of first contacts in the space and electrically connected to the processor; and
an electronic ticket card comprising a non-contact value-adding memory chip and a serial communication module including a plurality of second contacts adapted to connect to the first contacts when inserting the electronic ticket card in the space;
whereby the portable electronic device is operated to read an amount from the non-contact value-adding memory chip or write same thereinto through serial communication, enabling a user to know a disposable amount of the electronic ticket card immediately and add value thereto in time when the disposable amount is not sufficient.

5. The apparatus of claim 4, wherein the portable electronic device is a cellular phone.

6. The apparatus of claim 4, wherein the portable electronic device is a PDA.
